(19) United States
(12) Patent Application Publication
(10) Pub. No.: US 2008/0036841 A1
(43) Pub. Date: Feb. 14, 2008

(54) Anti-scattering device for keeping ultra violet beams from pringting heads of inkjet machine

(75) Inventors: Jih-Chiang Yu, Hsi Chih City (TW); Meng-Chou Hsieh, Hsi Chih City (TW); Hsien-Chang Lin, Hsi Chih City (TW); Chih-Te Yu, Hsi Chih City (TW)

Correspondence Address: TROXELL LAW OFFICE PLLC, 5205 LEESBURG PIKE, SUITE 1404, FALLS CHURCH, VA, 22041, US

(73) Assignee: Great Computer Corporation

(21) Appl. No.: 11/502,505

(22) Filed: Aug. 11, 2006

(51) Int. Cl. G03G 15/01

(52) U.S. Cl. 347/119

(57) ABSTRACT

A printing device for inkjet printing machine includes a base having a printing unit connected thereto and the printing unit includes a plurality of printing heads and ink cartridges. An UV beam generating device is connected to a side of the base and has an aperture defined in an underside thereof so that the UV beams goes through the aperture and toward an object to be printed. An anti-scattering device is connected between the printing heads and the aperture so as to keep the UV beams away from the nozzles of the printing heads.

### FIELD OF THE INVENTION

The present invention relates to an anti-scattering device located between the UV device and the printing unit to keep the UV beams from the printing heads of an inkjet machine.

### BACKGROUND OF THE INVENTION

A conventional inkjet machine generally includes a printing unit which includes a plurality of printing heads and ink cartridges. The printing unit can be moved along a rail so as to move the printing heads to desired positions and each printing head includes a nozzle from which the ink injects. In order to let the ink on the object to be printed to dry quickly, an Ultra Violet (UV) beam generating device connected to a side of the printing unit and generates UV beams which dries the ink on the object to be printed.

Although the UV beams are oriented to be perpendicular to the object to be printed, scattering happens and the nozzles on the printing heads are accessed by the scattering UV beams and this makes the ink dried on the nozzles. Once there are some particles of dried ink attached to the nozzles, the printing quality reduces. In order to keep the scattering UV beams from the printing nozzles, some inkjet printing machine install the printing unit at a distance from the UV beam generating device. Nevertheless, this requires a larger space for the printing machine.

The present invention intends to provide an anti-scattering device located between the UV beam generating device and the printing nozzles so as to keep the scattering UV beams away from the printing nozzles.

### SUMMARY OF THE INVENTION

The present invention relates to a printing device for inkjet printing machine and the printing device comprises a base having a printing unit connected thereto and the printing unit including a plurality of printing heads and ink cartridges. An UV beam generating device is connected to a side of the base and has an aperture defined in an underside thereof. The aperture faces an object to be printed. An anti-scattering device is connected between the printing heads and the aperture so as to stop scattering of the UV beams toward the printing heads.

The primary objective of the present invention is to provide an anti-scattering device which includes a plurality of ribs with inclined surfaces such that the UV beams cannot reach the nozzles of the printing heads.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the printing device of the present invention;

FIG. 2 shows that the anti-scattering device includes a plurality of ribs and each rib includes an inclined surface;

FIG. 3 is a side view to show that the UV beams are stopped by the ribs, and

FIG. 4 shows another embodiment of the present invention wherein the anti-scattering device is connected to a separation board located between the UV beam generating device and the printing heads.

### DETAILED DESCRIPTION OF THE PREFERRED EMBODIMENT

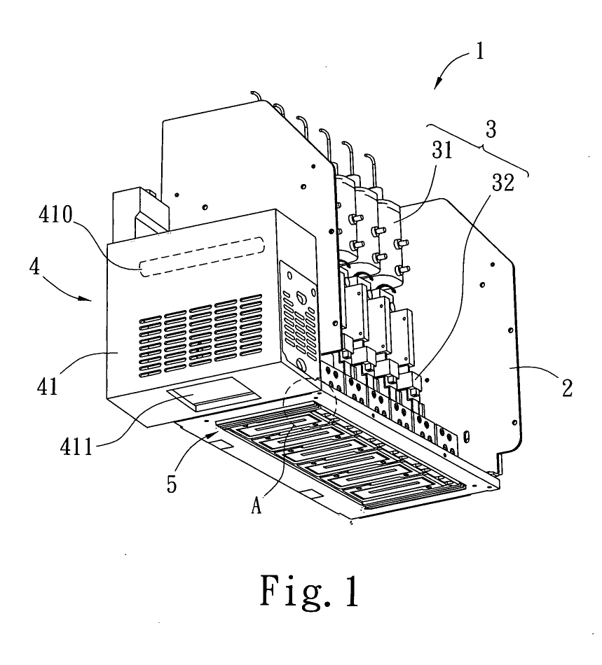

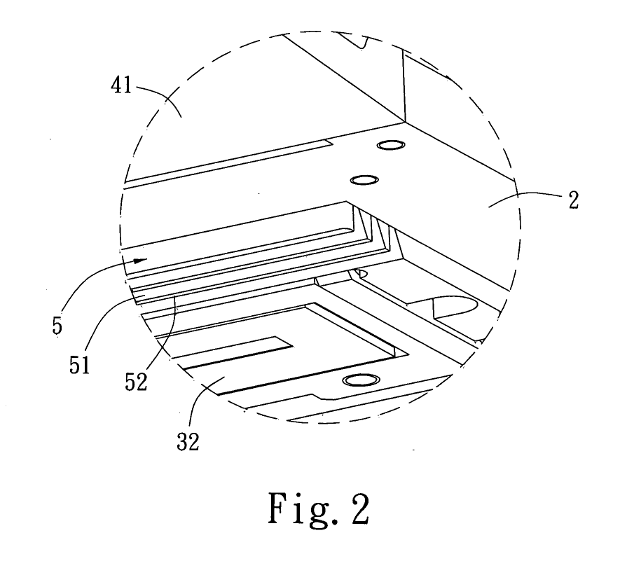

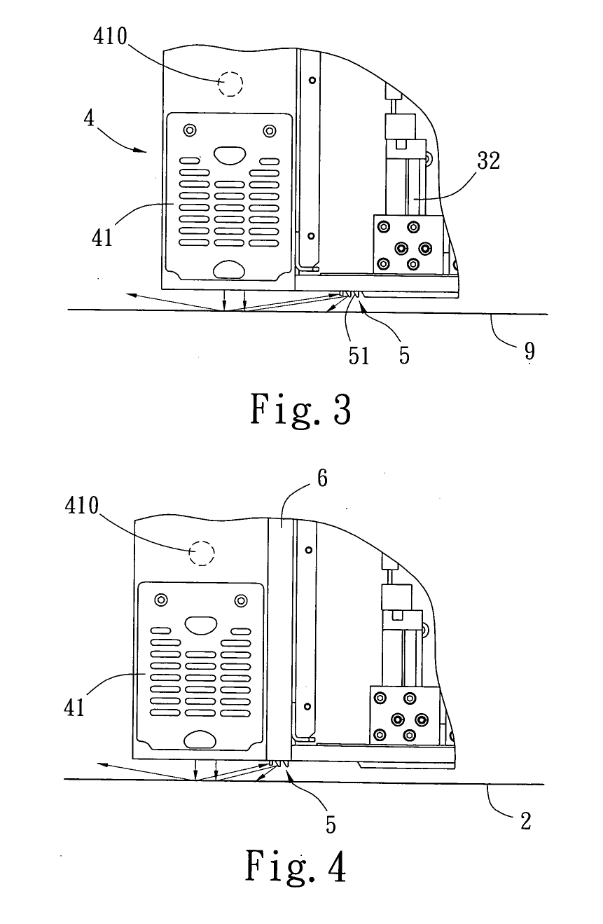

Referring to FIGS. 1 to 3, the printing device 1 of inkjet printing machine of the present invention comprises a base 2, a printing unit 3 and a UV beam generating device 4.

The base 2 is composed of a plurality boards and movable along a rail in the printing machine (not shown). The base 2 has a printing unit 3 connected thereto and the printing unit 3 includes a plurality of printing heads 32 and a plurality of ink cartridges 31 connected to the printing heads 32. Each printing head 32 includes a nozzle so that the ink injects from the nozzle.

The UV beam generating device 4 is connected to a side of the base 2 and includes a case 41 in which a UV bulb 410 is received. An aperture 411 is defined in an underside of the case 41 and faces an object 9 such as a paper sheet to be printed. The UV beams dry the ink on the object 9 quickly.

An anti-scattering device 5 is connected to an underside of the base 2 and located between the printing heads 32 and the aperture 411. The anti-scattering device 5 includes a plurality of ribs 52 and each rib 52 includes an inclined surface 51 so that the scattering UV beams are stopped and reflected back by the ribs 52 and the inclined surfaces 51. By the anti-scattering device 5, the ink on the nozzles of the printing heads 32 can be prevented from being dried by the UV beams. The anti-scattering device 5 can also be connected to the underside of the UV beam generating device 4.

FIG. 4 shows another embodiment of the present invention wherein the anti-scattering device 5 is connected to a separation board 6 which is located between the UV beam generating device 4 and the printing heads 32. The separation board 6 can be conveniently replaced so as to meet different needs of different printing machine.

The anti-scattering device 5 occupies a limited area so that the size of the printing device 1 can still be compact. The separation board 6 allows the user to install the anti-scattering device 5 to the old version of the printing machine and the anti-scattering device 5 can be made integrally with or separately from the separation board 6.

Thus, the present invention has the following advantages:

1. By providing the anti-scattering device, the UV beam can be prevented from scattering on the nozzles of the printing heads. Thus, the ink in the nozzles being quickly dry can be avoided.

2. By proving the anti-scattering device between the nozzle of the printing head and the aperture of an underside of the base to prevent the scattering UV beam, the volume of the present invention will not be therefore increased.

3. Additionally, by providing the anti-scattering device connected to a separation board for applying on the printing heads, there is no need to remake the base and the UV generating device.

While we have shown and described the embodiment in accordance with the present invention, it should be clear to those skilled in the art that further embodiments may be made without departing from the scope of the present invention.

What is claimed is:

1. A printing device for inkjet printing machine, comprising:
a base having a printing unit connected thereto and the printing unit including a plurality of printing heads and a plurality of ink cartridges;
an UV beam generating device connected to a side of the base and having an aperture defined in an underside thereof, the aperture facing an object to be printed, and an anti-scattering device connected between the printing heads and the aperture.

2. The device as claimed in claim 1, wherein the anti-scattering device includes a plurality of ribs and each rib includes an inclined surface.

3. The device as claimed in claim 1, wherein the anti-scattering device is connected to an underside of the base.

4. The device as claimed in claim 1, wherein the anti-scattering device is connected to the underside of the UV beam generating device.

5. The device as claimed in claim 4, wherein the UV beam generating device includes a case in which a UV bulb is received.

6. The device as claimed in claim 5, wherein a separation board is located between the base and the case of the UV beam generating device.

7. The device as claimed in claim 1, wherein the UV beam generating device includes a case in which a UV bulb is received.

8. The device as claimed in claim 7, wherein a separation board is located between the base and the case of the UV beam generating device.
